(19) United States
(12) Patent Application Publication
(10) Pub. No.: US 2011/0209063 A1
(43) Pub. Date: Aug. 25, 2011

(54) APPARATUS AND METHOD FOR PORTABLE MEDIA PLAYER NOTIFICATION

(75) Inventors: Steven L. Cooper, Whitestown, IN (US); Khelan M. Modi, Fishers, IN (US)

(73) Assignee: SHENZHEN TCL NEW TECHNOLOGY LTD., Shekou, Shenzhen, Guangdong (CN)

(21) Appl. No.: 13/125,556

(22) PCT Filed: Apr. 3, 2009
(86) PCT No.: PCT/US2009/039433

§ 371 Date: Apr. 21, 2011

(30) Foreign Application Priority Data
Nov. 17, 2008 (CN) 200810177611.8

(51) Int. Cl. G06F 3/048

(52) U.S. Cl. 715/716

(57) ABSTRACT

An electronic device includes an input for connecting to a portable media player, a user interface for providing notification of connection of the portable media player, and a processor for setting the media source to the input in response to selection of a portable media player indication displayed on the user interface. A method of providing notification may include detecting connection of a portable media player and displaying a notification menu. A method for setting the media source to the input may include detecting connection of a portable media player and setting the media source to the input if an auto-source option is enabled.

### FIELD OF THE INVENTION

The present invention relates generally to electronic devices, such as televisions. More specifically, the present invention relates to electronic devices configured to connect to a portable media player.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices, such as televisions, are often coupled to portable media players and used to play media files, such as audio files, video files, and digital picture files, stored on the portable media players. For example, a portable media player may be connected to an electronic device using a connection, such as a serial cable, that serves as one of various inputs to the electronic device. The connection may allow audio and video signals to be communicated between the portable media player and the electronic device when the portable media player is selected as a media source. When connected to an electronic device, a portable media player may be hidden from view, which may make it difficult for a user to discern whether a portable media player is connected to the electronic device.

### BRIEF DESCRIPTION OF THE DRAWINGS

In the drawings:

FIG. 1 is a block diagram of an electronic device in accordance with present embodiments;

FIG. 2 is a front elevational view of an electronic device connected to portable media players in accordance with present embodiments;

FIG. 3 is a process flow diagram of a method for providing notification that a portable media player is connected to an electronic device in accordance with present embodiments; and

FIG. 4 is a process flow diagram of a method for operating an electronic device in accordance with present embodiments.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Present embodiments are directed to an electronic device (e.g., a television) that facilitates access to and control of a portable media player. For example, a serial cable or wireless device may be used to transmit control signals, in addition to audio and video signals, between the portable media player and the electronic device. A media coupling or input (e.g., a port) on the electronic device associated with the portable media player may be selected to enable communication between the electronic device and the portable media player. However, the portable media player may be located within a cabinet of an entertainment center or behind a multi-media receiver. This may make it difficult for a user to know when a portable media device is connected to the electronic device and available for use.

Accordingly, present embodiments are direct to an electronic device that is configured to notify users when a portable media player is connected to the electronic device. The notification may include an on-screen display that allows a user to quickly select the portable media player as the media source for the electronic device. The notification not only informs the user that a portable media player is available, but also facilitates access to the portable media player through the electronic device. The notification may be displayed on the electronic device in response to activation of the electronic device. For example, the notification may be displayed after turning the device on or bringing the device out of standby mode.

According to present embodiments, upon connection of a portable media player, the electronic device may be configured to automatically switch the media source to the portable media player input. The automatic source switch may be provided as a setting, such as an auto-source option, that a user may enable or disable. When the setting is disabled, the electronic device may provide a notification without automatically switching the input source. When the setting is enabled, the electronic device may automatically switch the media source from a previous input to the portable media player input upon connection. Upon disconnection, the device may automatically return the media source to the previous input. The auto-source option allows a user to quickly access media stored on the potable media player. This feature may be particularly useful when a user is connecting a portable media player to the electronic device in order to immediately play media stored on the portable media player.

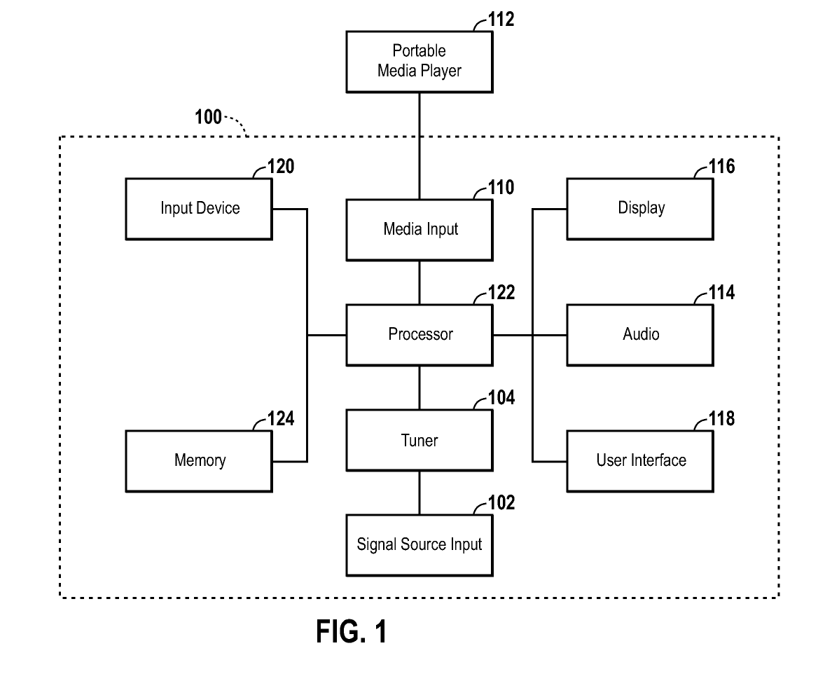

FIG. 1 is a block diagram of an electronic device in accordance with a present embodiment of the present invention. The electronic device is generally indicated by reference number 100. The electronic device 100 (a television, for example) comprises various subsystems represented as functional blocks in FIG. 1. Those of ordinary skill in the art will appreciate that the some of the functional blocks shown in FIG. 1 may comprise hardware elements (including circuitry), software elements (including computer code stored on a machine-readable medium), or a combination of both hardware and software elements.

The electronic device 100 includes a signal source input 102 for receiving media to present via the electronic device 100. The signal source input 102 may include an antenna input, an RCA jack, an S-video input, a composite video input, an HDMI input, or the like. Those of ordinary skill in the art will appreciate that the signal source input 102 may be representative of multiple inputs. The signal source input 102 is configured to receive a signal that comprises video data and, in some cases, audio data. The signal received by the signal source input 102 may comprise a broadcast spectrum (e.g., if the signal source input 102 comprises an antenna input) or a single channel of video and/or audio data (e.g., if the signal source input 102 comprises a DVD player input, or the like).

In the illustrated embodiment, a tuner 104 is configured to tune a particular video program from a broadcast signal received from the signal source input 102. For example, the tuner 104 may be used to select and tune a channel from a variety of channels provided through cable television to display a program being broadcast on the tuned channel. In some embodiments, the tuner 104 may be bypassed if the signal source input 102 receives a signal that does not require tuning, such as a stored video signal. Indeed, those of ordinary skill in the art will appreciate that input signals that are not received as part of a broadcast spectrum may bypass the tuner 104 because tuning is not required to isolate a video program associated with those signals.

The electronic device 100 also includes a media input 110 for receiving media to present via the electronic device 100. The media input 110 may include a wireless connection, a serial connection, a Universal Serial Bus (USB) connection, an Inter-Integrated Circuit (I²C) connection, or other suitable connection for communicating with an external unit, such as a portable media player 112.

The portable media player 112 includes a self-contained and portable electronic device configured to store and play digital media. Moreover, the portable media player 112 includes a device that is easily transported by a user and capable of independent use in a variety of environments, such as while traveling in a plane or while working out. For example, the portable media player 112 may include an audio, video, or multi-media player such as an iPod® commercially available from Apple, Inc., a Zune commercially available from Microsoft, a LYRA™ commercially available from RCA, or the like.

The portable media player 112 may be connected to the media input 110 by a cable, such as a serial cable or I²C cable, or may communicate with the media input 110 using wireless signals. Those of ordinary skill in the art will appreciate that the media input 110 may be representative of multiple inputs allowing connection to many portable media players and/or other external devices.

An audio subsystem 114 and a display subsystem 116 of the electronic device 100 are configured to play the audio and video information received from the signal source input 102 and the media input 110. The audio subsystem 114 may include an audio amplifier and one or more speakers configured to play audio data. For example, the audio subsystem 114 may play music received from the portable media player 112. The display subsystem 116 may include a lighting source and a display, such as a liquid crystal display, a light emitting diode display, a plasma display panel, or a digital light projection display configured to play video data. In operation, the display subsystem 116 may display album art or videos received from the portable media player 112. According to certain embodiments, the display subsystem 116 may display a menu for navigating within the portable media player 112.

A user interface 118 of the electronic device 100 may include a graphical user interface having a plurality of menus, viewable through the display subsystem 116. The user interface 118 may be configured to allow a user to adjust various settings and/or options for the electronic device 100. For example, a user may navigate through a series of menus to change the brightness and contrast settings for the electronic device 100. In another example, a user may navigate through a menu to select one of several signal source inputs 102 and media inputs 110 available on the electronic device 100 as a media source. The selection of the media source determines which input (e.g., 102 and 110) is used to provide media for presentation on the electronic device. For example, a user may select the media input 110 associated with the portable media player 112 to present media from the portable media player 112 on the electronic device 100. In some embodiments, multiple inputs may be used. For example, media received via an input designated as a primary input may be presented by a majority of a screen of the display subsystem 116 with media received via an input designated as a secondary input is presented in a smaller portion of the screen.

To facilitate selection of the media input 110, the user interface 118 may be configured to alert users when a portable media player 112 is connected to the electronic device. According to present embodiments, the user interface 118 may include a notification menu, such as a banner, icons, or window that may be displayed across a portion of, or all of, the display subsystem 116 to notify a user that the portable media player 112 is connected to the electronic device 100. The notification menu alerts a user that a portable media player is connected, thus, eliminating the need for a user to physically check the media inputs and/or navigate through a series of menus to determine if a portable media player is connected.

According to present embodiments, the notification menu may include selectable indications, such as icons, representing each portable media player 112 connected to the electronic device. A user may select an indication corresponding to a particular portable media player, such as portable media player 112, to set the media source for the electronic device to the input connected to the portable media player 112. Thus, the selectable indications allow a user to access a portable media player without having to navigate through a series of menus.

An input device 120, such as a remote control, may be configured to allow navigation within the user interface 118 and to facilitate selection of items within the user interface 118. For example, the input device 120 may be used to select an icon representing a portable media player. Upon selection of the icon, the electronic device may be configured to set the media source to the input corresponding to the selected portable media player. For example, in response to selection of an icon representing the portable media player 112, the electronic device may be configured to set the media source to media input 110.

The input device 120 may include control features such as buttons, dials, knobs, or the like, disposed on an outer surface of the device or on a remote control configured to communicate with the device via infrared signals. For example, a user may press a button, such as an arrow button, on the input device 120 to navigate between graphical icons representing different portable media players connected to the electronic device 100. Once an icon is selected, a user may press a “select” button to set the media source to the input corresponding to the selected portable media player. As discussed below, selection of the portable media player input may allow the user to access content stored on the portable media player 112 using the electronic device 100. Further, according to present embodiments, a user may be able to control the portable media player 112 using the electronic device 100.

A processor 122 of the electronic device 100 may be configured to control operation of the electronic device 100 and cooperate with a memory 124. The memory 124 may store executable code, data, and instructions for the processor 122. For example, the memory 124 may be configured to hold machine-readable code for accessing and operating the portable media player 112 in accordance with present embodiments. The processor 122 may utilize the code stored in the memory 124 to perform certain methods in accordance with present embodiments, including displaying a notification menu and automatically setting the media source to a portable media player input.

According to certain embodiments, the memory 120 may store machine-readable code for accessing and displaying the name of the portable media player 112 on the user interface 118. The memory 124 also may store menu configurations corresponding to menus of the portable media player 112 and icons for display on the notification menu. According to certain embodiments, the processor 122 and/or memory 124 may store protocol information and instructions for allowing communication with a portable media player, such as the portable media player 112.

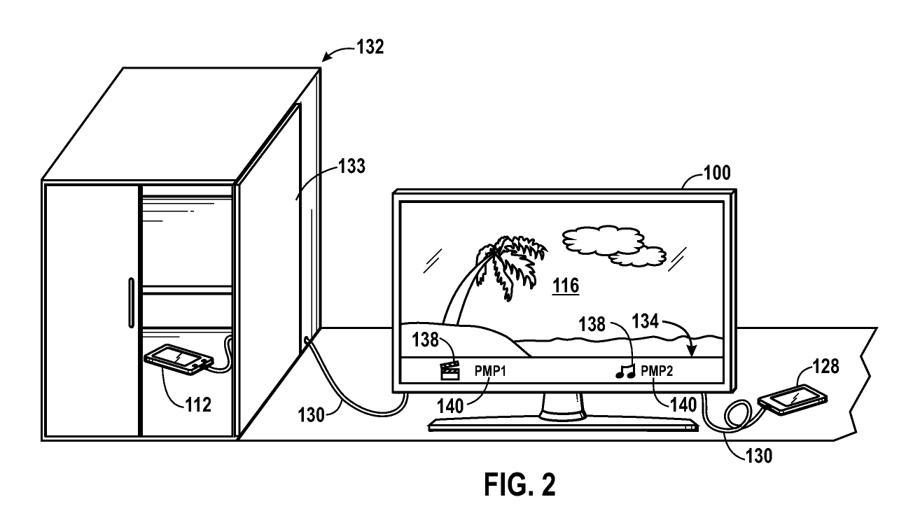

FIG. 2 is an illustration of an electronic device 100 connected to portable media players 112 and 128. Communication links 130, shown here as cables, connect the portable media players 112 and 128 to the electronic device 100. The communication links 130 may include serial cables, USB cables, wireless connections, or the like, and may be connected to media inputs 110 (FIG. 1) of the electronic device 100.

The portable media player 112 is located within a cabinet 132 that may hide the portable media player from view when a door 133 is closed. The location of the portable media player 112 may make it difficult for a user to know when the portable media player 112 is connected to the device 100. Furthermore, the connection of two portable media players 112 and 128 may make it difficult to discern which media input 110 (FIG. 1) is connected to each portable media player 112 and 128.

To provide notification that the portable media players 112 and 128 are connected, a notification menu 134, shown here as a banner, may be displayed on the electronic device 100. The notification menu 134 may partially obstruct an image 136, such as a movie scene or picture image, displayed on the device 100. According to present embodiments, the notification menu 134 may be transparent, allowing the image 136 to be viewed through at least portions of the notification menu 134. The notification menu 134 may include various configurations such as banners, scrolling text, and animated symbols, displayed on various locations, such as the top, bottom, or sides of the device 100. In some embodiments, the notification menu 134 may include light emitting devices, such as light emitting diodes, that may be disposed on a portion of the device 100 to indicate that certain inputs or ports are coupled to a portable media player.

The notification menu 134 may be displayed or activated in response to a control signal that activates the device 100, such as a signal configured to turn on the device or exit standby mode. In some embodiments, the notification menu 134 may only be displayed or activated when a portable media player is coupled to the device. Furthermore, a user may configure settings of the device 100 to specify when and how the notification menu 134 is displayed. For example, one setting may include displaying the notification menu 134 when a media input 110 is selected. Another setting may include designating the location of the notification menu 134 and the length of time that the notification menu 134 is displayed. According to present embodiments, the notification menu 134 may automatically disappear from view if it is not accessed within a specified time.

The notification menu 134 may include indications, such as icons 138 corresponding to each of the portable media players 112 and 128 connected to the electronic device 100. As depicted in FIG. 2, the icons 138 include a clapperboard icon corresponding to the portable media player 112 and a musical note icon corresponding to the portable media player 128. Each icon 138 corresponds to a media input 110. The electronic device 100 is configured to set the media source to a designated media input upon selection of an icon 138. According to present embodiments, an input device 120 (FIG. 1), such as a remote control, may be used to select one of the icons 138 and change the media source to an input corresponding to one of the portable media players 112 and 128. For example, the device 100 may be configured to select the media input 110 (FIG. 1) associated with portable media player 112 when the clapperboard icon 138 is selected.

Those skilled in the art will appreciate that various graphical icons and symbols may be used to represent the portable media players 112 and 128. According to present embodiments, icons corresponding to specific models of portable media players may be stored within the memory 124 (FIG. 1) and displayed on the notification menu 136 upon connection of a corresponding portable media player. For example, an icon pictorially representing a particular type of portable media player may be displayed upon connection of that particular type of portable media player. The use of corresponding icons provides a visual notification of the type of portable media player connected to the device 100. The icon may also represent the type of media available from the portable media player, such as music, video, or both.

A textual display 140 also may be included in the notification menu 136. According to certain embodiments, the textual display 140 may be used instead of, or in addition to, the icons 138. The textual display 140 may be configured to display information corresponding to the media inputs 110 that are configured to receive portable media player connections. For example, the first media input may be labeled as “PMP1” and the second media input may be labeled as “PMP2.” The labels may be disposed on the electronic device 100 near the media inputs to facilitate user identification of each input. The textual display 140 corresponds to the physical labels and notifies the user of the input connected to the portable media player. For example, if the user knows that his or her portable media player was connected to the input PMP1, then the user may select the icon 138 labeled as “PMP1” to access his or her portable media player.

However, selection of the desired portable media player using the labels may require the user to know the input to which the portable media player is connected. This requirement may be avoided by including text describing the portable media player within the textual display 140. For example, the text may display the name of the portable media player or the brand or model number of the portable media player. Such information may allow a user to easily recognize the desired portable media player. The portable media player information may be transmitted to the electronic device 100 through the communication link 130 upon connection of the portable media player 112 or 128. According to present embodiments, a protocol may be used to request and receive the portable media player information.

According to present embodiments, the notification menu 134 may be displayed in response to activation of the electronic device 100. For example, the electronic device 100 may be configured to display the notification menu 134 each time the device 100 is powered on or brought out of standby mode. If no portable media players are connected to the electronic device 100, a notification menu 134 may not be displayed. According to certain embodiments, a user may access a connected portable media player by selecting an icon 138 displayed on the notification menu 134. In response to selection of an icon 138, the electronic device 100 may be configured to set the media source to the input through which the portable media player represented by the icon 138 is connected.

The notification menu 134 also may be displayed automatically upon connection of a portable media player 112 or 128 to the device 100. The automatic display may alert a user that the portable media player has been connected correctly and provide identification of the port or input to which the portable media player has been connected. This feature may be particularly useful in situations where the communication links 130 are left connected to the device 100 to allow convenient connection and disconnection of the portable media players.

In addition to automatically displaying the notification menu 134, the electronic device 100 may be configured to automatically switch the media source to the newly connected input. For example, in response to connection of the portable media player 112 to media input 110, the electronic device may set the media source to media input 110. The automatic source selection allows a newly connected portable media player to be immediately accessed upon connection; no menu navigations or selections may be required. According to present embodiments, the automatic source switching may occur when an auto-source setting for the electronic device has been enabled.

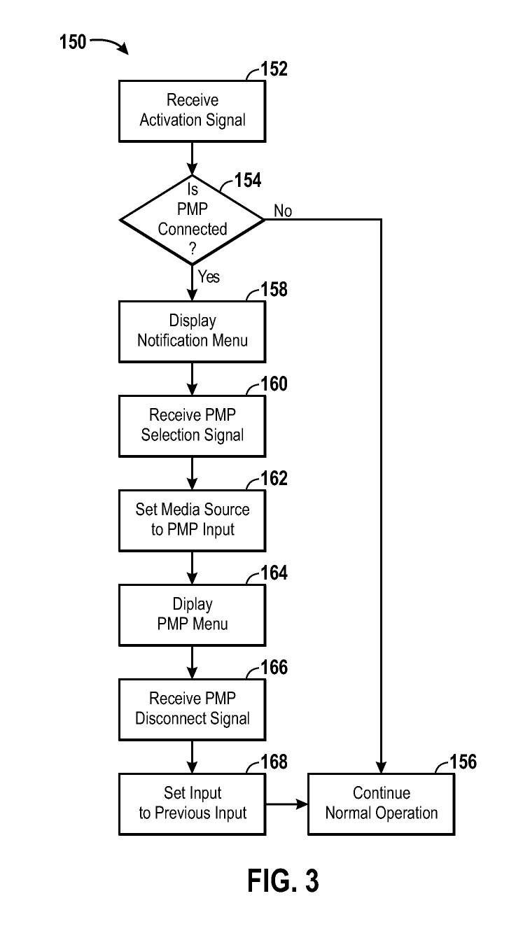

FIG. 3 is a process flow diagram of a method 150 for providing notification of connected portable media players in accordance with present embodiments. In some embodiments, as those of ordinary skills in the art will appreciate, some steps may be modified, excluded, or additional steps may be included. The method begins by receiving a signal to activate the electronic device (step 152). According to present embodiments, the signal may be received from an input device 120 (FIG. 1) and may relate to a command. For example, the signal may relate to a power on command or a volume up command that brings the device out of a standby mode. Upon receiving the signal, the device is configured to determine whether a portable media player is connected (step 154). If no portable media player is connected, the electronic device continues normal operation (step 156).

However, if the electronic device determines that a portable media player is connected, the device is configured to display a notification menu (step 158). As noted above, the notification menu 134 (FIG. 2) may include a pictorial display such as a banner including indications, such as icons, and/or textual displays. According to present embodiments, the indications may be selectable. For example, an input device 120 (FIG. 1) may be adapted to receive input from a user and send a selection signal to the electronic device that designates an input corresponding to one of the connected portable media players.

The device 100 (FIG. 1) is configured to receive the portable media player selection signal (step 160) and, in response to the signal, set the media source to the designated portable media player input (step 162). Once the portable media player input is set, the device may receive data stored on the portable media player. In certain embodiments, the device also is configured to display a portable media player menu (step 164) that facilitates user control of the portable media player. The portable media player menu may be stored within the memory 124 (FIG. 1) of the device 100 (FIG. 1) and accessed through the user interface 118 (FIG. 1). As those skilled in the art will appreciate, in certain embodiments, a portable media player menu may not be available. In these embodiments, step 164 may be omitted, and the portable media player controls may be used to directly control the portable media player.

Upon disconnection of the portable media player, the electronic device may receive a disconnect signal (step 166). The disconnect signal may be generated by the processor 122 (FIG. 1) upon detecting that the portable media player is no longer connected to one of the device inputs, such as the media input 110. In response to the disconnect signal, the electronic device may set the media source to the previous input (step 168). The previous input may be the input that was set as the media source immediately prior to connection of the portable media player, and the identity of the previous input may be stored within the memory 124 (FIG. 1). For example, if prior to connection of a portable media player, the device was set to receive a cable broadcast through a cable input, then after disconnection of the portable media player, the device may automatically return to the cable input and display cable broadcasting (step 168).

After returning the input to the previous input, the device continues normal operation (step 156). It should be noted that in certain embodiments, the electronic device might not be configured to return to the previous input. Therefore, in these embodiments, the device may remain on the portable media player input until receiving a signal from an input device to switch the media source to another input.

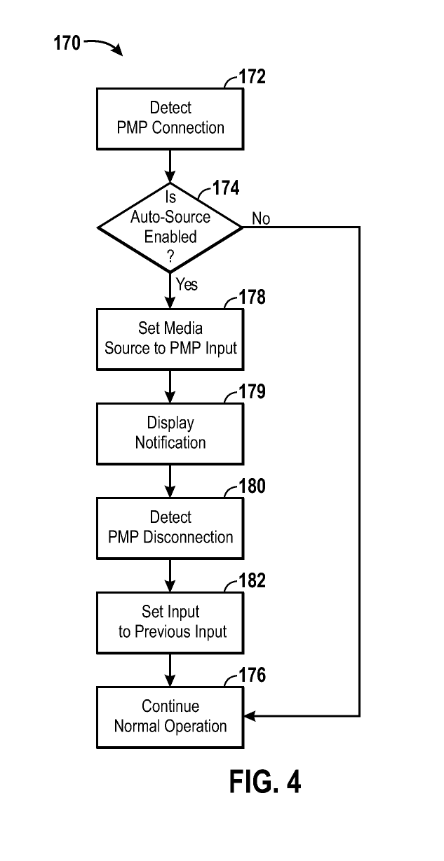

FIG. 4 is a process flow diagram of a method 170 for automatically switching to a portable media player input in accordance with present embodiments. In some embodiments, as those of ordinary skill in the art will appreciate, some steps may be modified, excluded, or additional steps may be included. The method begins with detecting connection of a portable media player (step 172). According to present embodiments, the detection may be performed using a protocol executed by the processor 122 (FIG. 1). The device 100 (FIG. 1) may be configured to detect connection to media inputs, such as the media input 110 (FIG. 1).

Upon detecting connection of a portable media player, the device 100 determines whether an auto-source option has been enabled (step 174). According to present embodiments, the auto-source option may be included within selectable settings of the electronic device 100 (FIG. 1) and may be selected by a user. For example, a user may use an input device 120 (FIG. 1) to navigate through a user interface 118 (FIG. 1) and select the auto-source option. If the auto-source option has not been enabled, the device continues normal operation (step 176).

If the auto-source option has been enabled, the device sets the media source to the portable media player input (step 178). For example, if the portable media player 112 (FIG. 1) is connected to the media input 110 (FIG. 1), the device 100 (FIG. 1) may automatically set the media source to media input 110 upon detecting connection of the portable media player 112. According to certain embodiments, the device may display a notification (step 179). The notification may be a graphical or textual display shown on the display subsystem 116 (FIG. 1) that provides information about the connected device. For example, the notification may include information about the portable media player, such as the make, model, or brand, and may alert a user that a portable media player has been successfully connected. It should be noted that in some embodiments, the device may not be configured to display a notification and this step may be omitted.

Once the media source is set to the portable media player input, the electronic device 100 may receive data from the portable media player 112. According to present embodiments, media files stored on the portable media player 112, such as video and audio files, may be played on the electronic device 100. The auto-source option allows a portable media player to be accessed quickly upon connection to an electronic device. By automatically switching the media source to the portable media input, the electronic device may be used to play media from the portable media player without navigating through menus to set the media source to the correct input.

The method continues with detecting disconnection of the portable media player (step 180). According to present embodiments, the detection may be performed using a protocol executed by the processor 122 (FIG. 1). Upon detecting disconnection of the portable media player, the electronic device sets the media source to the previous input (step 182). For example, if the media source was switched from a cable input to the portable media player input upon connection of the portable media player, then upon disconnection of the portable media player, the media source may be set back to the cable input. According to present embodiments, the identity of the previous input may be stored within the memory 124 (FIG. 1) of the device 100 (FIG. 1) and code stored within the memory 124 may be executed by the processor 122 (FIG. 1) to set the media source to the previous input. After the media source has returned to the previous input, the device resumes normal operation (step 176).

According to present embodiments, the method 150 (FIG. 3) for providing notification may be used in conjunction with the method 170 (FIG. 4) for automatically switching to a portable media player input. As shown in FIG. 4, if the auto-source option is not enabled, the device may continue normal operation (step 176). However, as those skilled in the art will appreciate, the normal operation may include determining whether a portable media player is connected (step 154, FIG. 3) and displaying a notification menu (step 158, FIG. 3). Indeed, each of the steps 152, 154, 158, 160, 162, 164, 166, and 168 shown in FIG. 3 may be applied to the method 170 (FIG. 4) when the auto-source option is not enabled. Furthermore, in certain embodiments, the step of receiving an activation signal (step 152, FIG. 3) may include determining that the auto-source option is not enabled (step 174, FIG. 4).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An electronic device, comprising:
a plurality of inputs including a first input configured to receive a communication link for a portable media player;
a user interface configured to display a selectable indication in response to connection of the portable media player to the first input; and
a processor configured to set the first input as a media source in response to selection of the indication.

2. The device of claim 1, comprising:
a tuner configured to tune a desired program; and
a display subsystem configured to display the selectable indication and to play video data corresponding to the desired program, wherein the video data is received through a second input of the plurality of inputs.

3. The device of claim 1, wherein the indication is displayed on a banner partially obstructing an image displayed on the display subsystem.

4. The device of claim 1, comprising a memory that includes machine-readable code configured to select the first input in response to detecting connection of the portable media player.

5. The device of claim 1, comprising a user interface that includes a plurality of selectable indications, wherein each indication corresponds to an input configured to receive a communication link for a portable media player.

6. The device of claim 1, wherein the indication includes information received from the portable media player.

7. The device of claim 1, comprising a user interface for enabling an auto-source option, wherein the processor is configured to set the media source to the first input in response to connection of the portable media player when the option is enabled.

8. The device of claim 7, wherein the processor is configured to set and return the media source to a second input of the plurality of inputs in response to disconnection of the portable media player when the option is enabled.

9. A method of operating an electronic device, the method comprising:
detecting connection of a portable media player to a first input of the device;
setting a media source of the device to the first input in response to detecting the connection;
detecting disconnection of the portable media player; and
setting and returning the media source to a previous input in response to detecting the disconnection.

10. The method of claim 9, comprising verifying enablement of an auto-source option and maintaining the second input as the media source when the auto-source option is disabled.

11. The method of claim 10, comprising enabling the auto-source option in response to selection of the option through a user interface displayed on a display subsystem of the device.

12. The method of claim 10, comprising displaying a notification menu when the auto-source option is disabled, wherein the notification menu includes a selectable indication configured to set the media source to the first input in response to selection of the indication.

13. The method of claim 9, comprising playing media received through the first input on a display subsystem of the device while the first input is set as the media source, playing media received through the previous input prior to connection of the portable media player, and playing media received through the previous input after disconnection of the portable media player.

14. The method of claim 9, comprising storing an identity of the previous input in a memory of the device.

15. The method of claim 9, comprising displaying a media guide for the portable media player in response to the detecting connection.

16. A method of operating an electronic device, the method comprising:
detecting connection of a portable media player to a first input;
displaying a notification menu configured to allow selection of the first input; and
switching from a second input to the first input responsive to selection of the first input.

17. The method of claim 16, comprising displaying an indication corresponding to the portable media player on the notification menu.

18. The method of claim 17, comprising receiving a signal selecting the indication.

19. The method of claim 16, comprising displaying a portable media player menu configured to allow control of the portable media player, wherein the menu is displayed in response to selection of the first input.

20. The method of claim 16, comprising:
detecting connection of a plurality of portable media players; and
displaying a plurality of selectable indications on the notification menu, wherein each indication corresponds to each of the portable media players.
